(19) United States
(12) Patent Application Publication
(10) Pub. No.: US 2007/0115251 A1
(43) Pub. Date: May 24, 2007

(54) Electro phoretic display device and driving method of the same

(75) Inventor: Jun-hyung Kim, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/603,457

(22) Filed: Nov. 21, 2006

(30) Foreign Application Priority Data
Nov. 22, 2005 (KR) 2005-0112034

(51) Int. Cl. G09G 3/34

(52) U.S. Cl. 345/107

(57) ABSTRACT

An electro phoretic display device comprises: a first substrate including a first electrode; a second substrate including a second electrode positioned facing the first substrate; a plurality of spaces formed between the first electrode and the second electrode; fluid including a plurality of charged particles disposed in the spaces; and one or more gel members dividing the spaces. Embodiments of the present invention provide an electro phoretic display device with improved flexibility.

### CROSS-REFERENCE TO RELATED APPLICATIONS

This application claims the benefit of Korean Patent Application No. 2005-0112034, filed on Nov. 22, 2005, in the Korean Intellectual Property Office, the disclosure of which is incorporated herein by reference.

### BACKGROUND OF THE INVENTION

1. Field of the Invention

The present invention relates to an electro phoretic display device and a manufacturing method of an electro phoretic indication display.

2. Description of the Related Art

An electro phoretic display device is one type of flat display device, and is typically used for e-book (electronic book) applications. An electro phoretic display device comprises two substrates with electrodes formed thereon and facing one another, and includes charged particles between the two substrates. An electro phoretic display device applies a potential difference between the electrodes that are positioned facing one another. The charged particles move away from the electrode with the same polarity and toward the electrode having the opposite polarity with respect to the charged particles, and the device thereby displays an image.

An electro phoretic display device has high reflectivity and contrast ratio, and the display does not depend on a viewing angle. As a result, an electro phoretic display device can stably display the image like paper. Further, the electro phoretic display device is bistable and maintains the image without needing to continuously apply the voltage, thereby reducing power consumption. Unlike a liquid crystal display (LCD), an electro phoretic display device does not need a polarizing plate, an arrangement layer, liquid crystals, etc., and thus may be manufactured at a lower cost.

However, for some applications, electro phoretic display devices are not flexible enough.

### SUMMARY OF THE INVENTION

Accordingly, it is an aspect of the present invention to provide an electro phoretic display device with improved flexibility.

Another aspect of the present invention is to provide a manufacturing method of an electro phoretic display device which has excellent flexibility.

The foregoing and/or other aspects of the present invention are achieved by providing an electro phoretic display device comprising: a first substrate including a first electrode; a second substrate including a second electrode positioned facing the first substrate; a plurality of spaces formed between the first electrode and the second electrode; fluid including a plurality of charged particles disposed in the spaces; and one or more gel members dividing the spaces.

According to an embodiment of the present invention, at least a one of the plurality of spaces is in direct contact with at least one of the first substrate and the second substrate.

According to an embodiment of the present invention, at least a part of one of the plurality of spaces extends in a substantially perpendicular direction to a surface of the first substrate.

According to an embodiment of the present invention, at least one the plurality of spaces is encompassed by the one or more gel members.

According to an embodiment of the present invention, an average cross-sectional small dimension of the plurality of spaces is 100 times to 10000 times an average cross-sectional large dimension of the plurality of charged particles.

According to an embodiment of the present invention, an average diameter of the plurality of spaces is included in the range extending from 10 μm to 100 μm.

According to an embodiment of the present invention, the one or more gel members comprise an inorganic material.

According to an embodiment of the present invention, the one or more gel members comprise silica.

According to an embodiment of the present invention, the first electrode and the second electrode are configured to generate an electric field therebetween, and wherein the plurality of charged particles are configured to move up and down in response to the electric field generated between the first electrode and the second electrode.

According to an embodiment of the present invention, the plurality of charged particles comprise white sub-particles.

According to an embodiment of the present invention, the plurality of charged particles comprise white sub-particles and black sub-particles, where the white sub-particles and black sub-particles have opposite polarities.

According to an embodiment of the present invention, the first substrate comprises an insulating substrate and a TFT formed on the insulating substrate, and wherein the first electrode is connected to the TFT.

According to an embodiment of the present invention, the first electrode is included in a plurality of first electrodes, and at least one of the plurality of spaces face at least two first electrodes.

According to an embodiment of the present invention, the first electrode is included in a plurality of first electrodes, and at least one of the plurality of first electrodes face at least two spaces.

According to an embodiment of the present invention, at least one of the first substrate and the second substrate comprises a plastic insulating substrate.

According to an embodiment of the present invention, the fluid is a transparent organic solution.

According to an embodiment of the present invention, the total volume of the one or more gel members is 20% to 100% of the total volume of the plurality of spaces.

The foregoing and/or other aspects of the present invention are also achieved by providing a manufacturing method of an electro phoretic display device comprising: providing a first substrate including a first electrode; adhering a film-type gel member comprising a plurality of spaces to the first electrode; providing a fluid and charged particles into the plurality of spaces; and adhering a second substrate including a second electrode to the gel member.

According to an embodiment of the present invention, the gel member comprises an inorganic material.

According to an embodiment of the present invention, the first electrode is included in a plurality of first electrodes, and at least a one of the plurality of spaces face at least two first electrodes.

According to an embodiment of the present invention, the first electrode is included in a plurality of first electrodes, and at least a one of the first electrodes face at least two spaces.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1 schematically illustrates a driving principle of an electro phoretic display device according to an exemplary embodiment of the present invention;

FIG. 2 is a sectional view of an electro phoretic display device according to a first embodiment of the present invention;

FIG. 3 is an exploded perspective view of the electro phoretic display device according to the first embodiment of the present invention;

FIG. 4 is a flow chart to illustrate a manufacturing method of the electro phoretic display device according to the first embodiment of the present invention; and

FIG. 5 is a sectional view of an electro phoretic display device according to a second embodiment of the present invention.

### DETAILED DESCRIPTION

Reference will now be made in detail to exemplary embodiments of the present invention, examples of which are illustrated in the accompanying drawings, wherein like reference numerals refer to like elements throughout. The embodiments are described below in order to explain the present invention by referring to the figures.

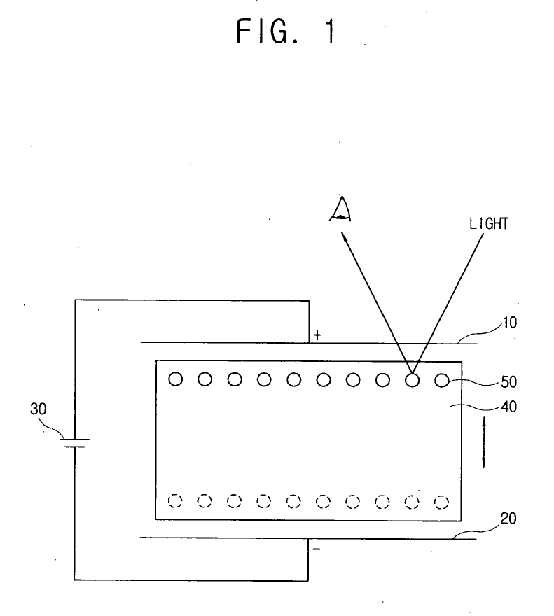

First, a driving principle of an electro phoretic display device according to an exemplary embodiment of the present invention will be described with reference to FIG. 1.

As shown in FIG. 1, an electro phoretic display device according to an exemplary embodiment of the present invention comprises a pair of electrodes 10 and 20. By applying a potential difference between electrode 10 and electrode 20 an electric field is generated between the electrodes. The pair of electrodes 10 and 20 comprise a pixel electrode and a common electrode. The potential difference between electrode 10 and electrode 20 depends on a voltage applied by a power supply 30. A fluid 40 is dispersed between electrode 10 and electrode 20, and charged particles 50 are dispersed in the fluid 40. The charged particles 50 are either positive or negative and either black or white.

In an electro phoretic display device according to the exemplary embodiment of the present invention, if a voltage is applied to electrodes 10 and 20 to generate the potential difference (+, −) therebetween, the charged particles 50 move up and down from one electrode to the other electrode having the opposite polarity. Accordingly, an observer recognizes light reflected by the charged particles. If the charged particles 50 move up to (toward) the observer, the observer perceives the colors of the charged particles 50 as more intense. If the charged particles 50 move down (away), the observer perceives the colors of the charged particles 50 as less intense (paler).

The charged particles 50 move by electrophoresis, a phenomenon in which a particle of a surface charge moves in an electric field to an electrode having an opposite charge. Electrophoresis is not merely an electromagnetic phenomenon, but can be interpreted by colloidal science and fluid mechanics.

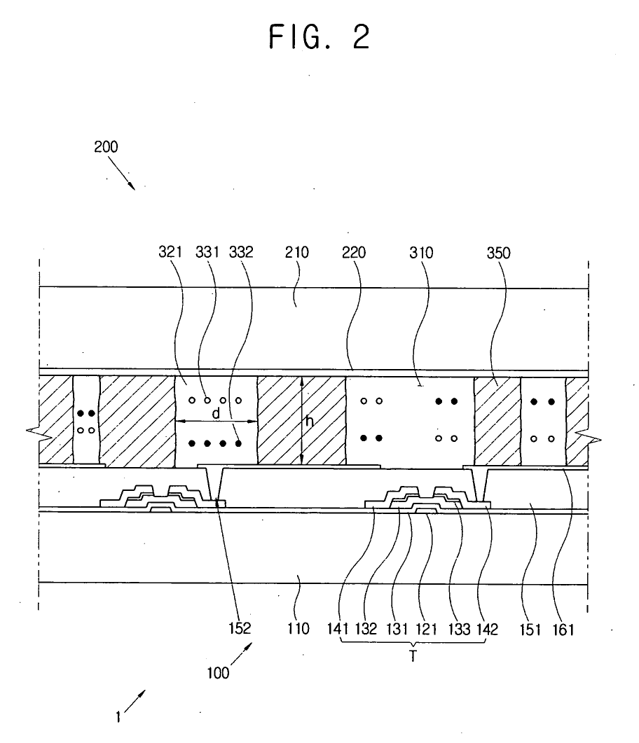

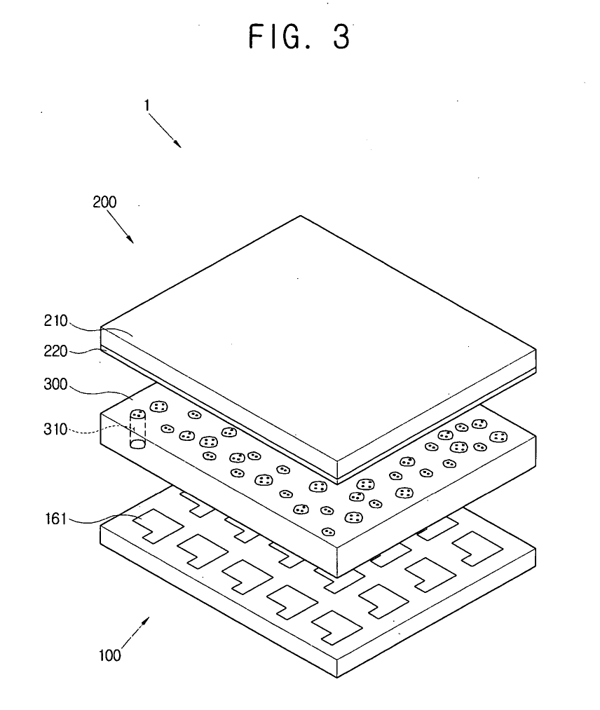

An electro phoretic display device 1 according to a first embodiment of the present invention will be described with reference to FIGS. 2 and 3.

The electro phoretic display device 1 comprises a first substrate 100, a second substrate 200 facing the first substrate 100, and a gel member 350 disposed between first substrate 100 and second substrate 200. The gel member 350 divides spaces 310. Fluid 321 and charged particles 331 and 332 dispersed in the fluid 321 are disposed in each space 310.

A gate electrode 121 is formed on a first insulating substrate 110. The gate electrode 121 may be a single layer structure with low resistivity, or may be a multi-layer structure including a -layer with low resistivity and a layer with good contact properties. For example, a single layer structure for gate electrode 121 may comprise a low resistivity material such as silver (Ag), silver alloy, aluminum (Al) or aluminum alloy. A multi-layer structure for gate electrode 121 may include the low resistivity layer and another layer comprising chrome (Cr), titanium (Ti), tantalum (Ta) or other material with good contact properties.

A gate insulating layer 131 of silicon nitride (SiNx) covers the gate electrode 121 on the first insulating substrate 110.

A semiconductor layer 132 of amorphous silicon is formed on the gate insulating layer 131. An ohmic contact layer 133 made of n+ hydrogenated amorphous silicon which is highly doped with silicide or n-type dopant is formed on the semiconductor layer 132. The ohmic contact layer 133 is divided into two regions with respect to the gate electrode 121.

A data line assembly 141 and 142 is formed on the ohmic contact layer 133 and the gate insulating layer 131. The data line assembly 141 and 142 may comprise silver or aluminum which has low resistivity, and/or a conductive material with good contact properties. The data line assembly 141 and 142 comprises a source electrode 141 disposed on one region of the ohmic contact layer 133, and a drain electrode 142 separated from the source electrode 141 and disposed on the region of ohmic contact layer 133 opposite the source electrode 141, across the gate electrode 121.

A passivation layer 151 is formed on the data line assembly 141 and 142 and a portion of the semiconductor layer 132 which is not covered with the data line assembly 141 and 142. The passivation layer 151 comprises a material such as silicon nitride, an a-Si:C:O layer or an a-Si:O:F which is deposited by a plasma enhanced chemical vapor deposition (PECVD) method, an acrylic organic insulating layer, or the like. A contact hole 152 exposing the drain electrode 142 is formed in the passivation layer 151.

A pixel electrode 161 is formed on the passivation layer 151. The pixel electrode 161 generally comprises a transparent conductive material such as indium tin oxide (ITO) or indium zinc oxide (IZO).

A plurality of pixel electrodes 161 are connected to the TFTs T is arranged regularly on the first substrate 100, as shown in FIG. 3.

Referring to a second substrate 200, a common electrode 220 is formed on a second insulating substrate 210.

The common electrode 220 generally comprises a transparent conductive material such as ITO or IZO. The common electrode 220 is formed across the second insulating substrate 210 and a potential difference between common electrode 220 and each of the pixel electrodes 161 forms an electric field in the region between the common electrode 220 and a pixel electrode 161 to drive charged particles 331 and 332 which are positive or negative.

At least one of the first insulating substrate 110 and the second insulating substrate 210 may be transparent, and at least one of-the first insulating substrate 110 and the second insulating substrate 210 may comprise a plastic material. The plastics may be polycarbon, polyimide, polyethersulfone (PES), polyarylate (PAR), polyethylenenaphthalate (PEN), polyethyleneterephthalate (PET), or other appropriate plastic material. If the insulating substrates 110 and 210 comprise plastics, the electro phoretic display device 1 may be relatively light, slim and flexible.

The gel member 350 is disposed between the first substrate 100 and the second substrate 200 to divide the spaces 310, in which the fluid 321 and the charged particles 331 and 332 are disposed.

The fluid 321 may have a low viscosity so that the charged particles 331 and 332 may have high mobility. Further, the fluid 321 may have a low dielectric constant to restrict chemical reaction. Preferably, the fluid 321 is transparent to improve reflecting brightness. The fluid 321 comprises, for example, hydrocarbon such as decahydronaphthalene, 5-ethylidene-2-norbornene, fat oil or paraffin oil; aromatic hydrocarbon such as toluene, xylene, phenylxylylethane, dodecyl benzene or alkylnaphthalene; and a halogenated solvent such as perfluorodecalin, perfluorotoluene, perfluoroxylene, dichlorobenzotrifluoride, 3,4,5-trichlorobenzotrifluoride, chloropentafluoro-benzene, dichlorononane or pentachlorobenzene.

The charged particles 331 and 332 dispersed in the fluid 321 comprise white sub-particles 331 and black sub-particles 332. The white sub-particles 331 and the black sub-particles 332 are charged with different polarities from each other, and thus they move in opposite directions in an electric field. The white sub-particles 331 comprise titanium oxide (TiO₂) or silica (SiO₂). The black sub-particles 332 comprise carbon black, or TiO₂ or SiO₂ colored with a black pigment.

The charged particles 331 and 332 move up and down in response to the electric field generated between the pixel electrode 161 and the common electrode 220, to adjust the amount of reflected light. For example, when the white sub-particles 331 move up and the black sub-particles 332 move down, a white color is displayed. By contrast, when the white sub-particles 331 move down and the black sub-particles 332 move up, a black color is displayed. A single pixel electrode 161 can display a gray color as well.

The charged particles 331 and 332 may have their own charges, be charged by a charge control agent, or obtain charges while drifting in the solvent. The charge control agent may be polymer or non-polymer, ionic or non-ionic, and may comprise sodium dodecylsulfonate, metal soap, polybutene succineimide, maleic anhydride copolymer, vinyl piridine copolymer, vinylpirolidone copolymer, acrylic(metacryl) acid copolymer, or other appropriate material.

Particles dispersed in the fluid 321, such as charged particles 331 and 332, charge control agent particles, or the like, should be in colloidal stability each other. The colloidal stability may be achieved by adjusting the size of the particles and a surface charge thereof.

The gel member 350 divides the spaces 310. The gel member 350 has a porous shape, i.e. a film shape in which the spaces 310 are scattered, as shown in FIG. 3. Preferably, the gel member 350 is transparent.

A gel is formed from a colloidal solution (sol) when the colloidal solution (sol) reaches or exceeds a certain concentration, and the colloidal solution forms a network to form the gel. Examples of gels are agar, silica gel, and other gel types which are formed by hardening of the material in a dispersion medium, such as water, in which the network of colloidal particles is dispersed. The gel becomes fluid by heating, since the network is broken by molecular motions or the like. A hydrogel is a gel in which water is the dispersion medium. A xerogel is a porous gel in which air is the dispersion medium. Xerogels include, for example, diatomite, acid clay, etc.

Referring again to the spaces 310, the spaces 310 are disposed between the first substrate 100 and the second substrate 200. In the illustrated embodiment, spaces 310 extend in a direction perpendicular to surfaces of the substrates 100 and 200. Preferably, the volume of each space 310 exceeds the size of the charged particles 331 and 332 sufficiently, so that the charged particles 331 and 332 (typically of nanometer dimension) may move up and down easily. In an embodiment, the spaces 310 have an average diameter d1 of 10 μm to 100 μm, which is about 100 times to 10,000 times an average diameter of the charged particles 331 and 332. For embodiments in which the spaces 310 and/or particles 331 and 332 do not have a single diameter, the applicable dimensions may have the above relationship. For example, the average cross-sectional small dimension of spaces 310 may be in the range from 10 μm to 100 μm, which may be about 100 to 10,000 times the average cross-sectional large dimension of particles 331 and 332. For example, for a particular space 310 with an elliptical cross section that varies along the longitudinal extent of the space, the cross-sectional small dimension refers to the smallest minor axis. For particles 331 and 332, the cross-sectional large dimension refers to the largest straight-line distance between points on the surface.

One or more spaces 310 directly contact one or more pixel electrodes 161 on the first substrate 100 and the common electrode 220 on the second substrate 200. Some spaces 310 face a single pixel electrode 161, but other spaces 310 face two or more pixel electrodes 161. Likewise, some pixel electrodes 161 face two or more spaces 310. The charged particles 331 and 332 in a particular space 310 move in different directions if they face different pixel electrodes 161. Although the spaces 310 do not generally correspond to the pixel electrodes 161 one-by-one, the movement of the charged particles 331 and 332 is controlled by the pixel electrodes 161 to form a desired image.

The volume occupied by the gel member 350 positioned between the first substrate 100 and the second substrate 200 may be in a range of 20% and 100% of the volume of the space 310. If the volume of the gel member 350 is less than 20% of the volume of the space 310, the strength of the gel member 350 may not be sufficient. On the contrary, if the volume of the gel member 350 is more than 100% of the volume of the spaces 310, the volume of spaces 310 may be insufficient to provide the desired resolution.

As mentioned above, the electro phoretic display device 1 uses the gel member 350 to divide the spaces 310. The gel member 350 is improved in flexibility compared to that of a conventional wall, thereby increasing flexibility of the electro phoretic display device 1. The gel member 350 reduces loss of the fluid 321 and the charged particles 331 and 332 if the electro phoretic display device 1 is broken. Further, the gel member 350 in a solid state maintains a cell gap between the first substrate 100 and the second substrate 200. Therefore, an additional spacer is not needed. In some embodiments, the height (h) of the gel member 350 may be several micrometers to tens of nanometers.

The response time of the electro phoretic display device 1 may be controlled by adjusting the thickness of the gel member 350 and the voltage applied to the pixel electrodes 161 and common electrode 220.

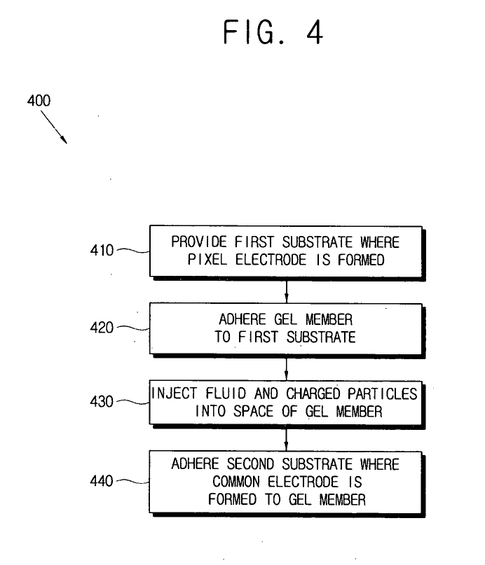

A method 400 to manufacture an electro phoretic display device according to the first embodiment of the present invention will be described, with reference to FIGS. 1-4.

First, the first substrate 100 where the pixel electrodes 161 are formed is provided (at 410). The first substrate 100 comprises TFTs T and the pixel electrodes 161 connected to the TFTs T. The first substrate 100 may be manufactured by methods known to persons skilled in the art, which are not described here.

The gel member 350 adheres to the pixel electrodes 161 (at 420). For example, a film-type gel member 350 may be laminated on the pixel electrodes 161 so that gel member 350 is adhered to first substrate 100. Pores, i.e. the spaces 310, are randomly distributed in the gel member 350 and extend in a thickness direction of the gel member 350.

The fluid 321 and the charged particles 331 and 332 are injected into the spaces 310 of the gel member 350 (at 430). This is performed, for example, by depositing part or all of the gel member 350 into the fluid 321 in which the charged particles 331 and 332 are dispersed. In this example, the fluid 321 comprising the charged particles 331 and 332 is injected to the spaces 310 by capillarity or the like.

At 440, the second substrate 200 (where the common electrode 220 is formed) adheres to the gel member 350, to complete the electro phoretic display device 1 shown in FIG. 2.

A sealant (not shown) may be used to attach the first substrate 100 and the second substrate 200.

In some embodiments, the gel member 350 may adhere to the pixel electrode 161 with at least one of the fluid 321 and the charged particles 331 and 332 already injected into the spaces 310. In some embodiments, the gel member 350 may adhere to the second substrate 200 first, and may then be attached to the first substrate 100.

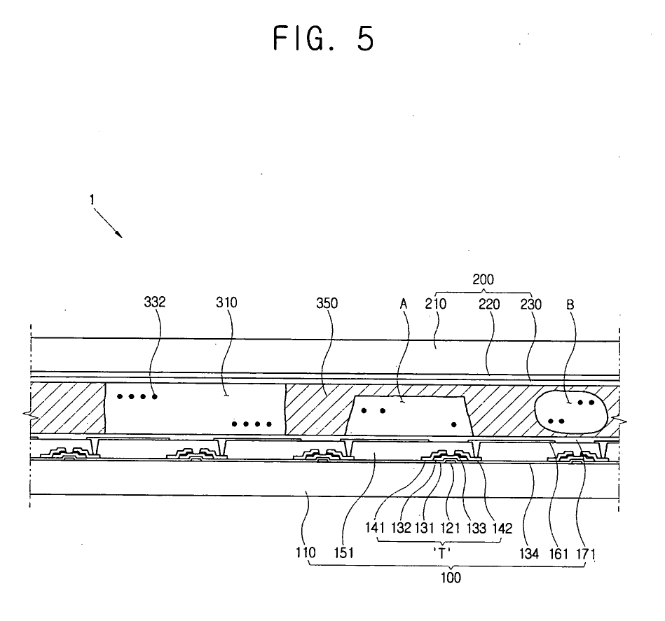

Hereinafter, an electro phoretic display device 1 according to a second embodiment of the present invention will be described with reference to FIG. 5. It should be noted that the following description emphasizes the features that are different than those of the first embodiment, and discussion of similar features may not be repeated herein.

A first substrate 100 further comprises a first sealing/adhering layer 171 formed on a pixel electrode 161. A second substrate 200 further comprises a second sealing/adhering layer 230 in contact with a fluid 321 and a gel member 350. The sealing/adhering layers 171 and 230 adhere to the gel member 350 to prevent charged particles 332 in one space 310 from moving to another space 310. The sealing/adhering layers 171 and 230 may comprise polymer.

In some embodiments, display device 1 is formed by adhering the sealing/adhering layers 171 and 230 to opposite sides of the gel member 350, and then adhering layers 171 and 230 to the first substrate 100 and the second substrate 200. In some embodiments, display device 1 is formed by adhering the sealing/adhering layers 171 and 230 to the first substrate 100 and the second substrate 200, and then adhering layers 171 and 230 to the gel member .350.

By contrast to the first embodiment described above, the charged particles 332 are only black. The charged particles 332 move up to display a black color, and move down to display a white color. The spaces 310 in the second embodiment may be provided in various configurations. For example, the gel member 350 may be disposed between one or more of the spaces 310 and the second substrate 200 as shown in ‘A’, or one or more of the spaces 310 may be encompassed by the gel member 350 as shown in ‘B’. These different configurations for spaces 310 may also be used in other embodiments, such as the first embodiment.

The movement of the charged particles 332 is controlled by the pixel electrode 161 disposed therebelow, and thus an image is formed regardless of the shape of the space 310.

As described above, embodiments of the present invention provide an electro phoretic display device with improved flexibility.

Further, embodiments of the present invention provide a manufacturing method for an electro phoretic display device with improved flexibility.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An electro phoretic display device comprising:
a first substrate including a first electrode;
a second substrate including a second electrode, wherein the second electrode is positioned facing the first substrate;
one or more gel members dividing a plurality of spaces formed between the first electrode and the second electrode; and
a fluid including a plurality of charged particles disposed in the plurality of spaces.

2. The electro phoretic display device according to claim 1, wherein at least one of the plurality of spaces is in direct contact with at least one of the first substrate and the second substrate.

3. The electro phoretic display device according to claim 1, wherein at least a part of one of the plurality of spaces extends in a substantially perpendicular direction to a surface of the first substrate.

4. The electro phoretic display device according to claim 1, wherein at least one of the plurality of spaces is encompassed by the one or more gel members.

5. The electro phoretic display device according to claim 1, wherein an average cross-sectional small dimension of the plurality of spaces is 100 times to 10000 times an average cross-sectional large dimension of the plurality of charged particles.

6. The electro phoretic display device according to claim 1, wherein an average cross sectional large dimension of the plurality of spaces is included in the range extending from 10 μm to 100 μm.

7. The electro phoretic display device according to claim 1, wherein the one or more gel members comprise an inorganic material.

8. The electro phoretic display device according to claim 7, wherein the one or more gel members comprise silica.

9. The electro phoretic display device according to claim 3, wherein the one or more gel members comprise an inorganic material.

10. The electro phoretic display device according to claim 9, wherein the one or more gel members comprise silica.

11. The electro phoretic display device according to claim 1, wherein the first electrode and the second electrode are configured to generate an electric field therebetween, and wherein the plurality of charged particles are configured to move up and down in response to the electric field generated between the first electrode and the second electrode.

12. The electro phoretic display device according to claim 1, wherein the plurality of charged particles comprise white sub-particles.

13. The electro phoretic display device according to claim 1, wherein the plurality of charged particles comprise white sub-particles and black sub-particles, and wherein the white sub-particles and black sub-particles have opposite polarities.

14. The electro phoretic display device according to claim 1, wherein the first substrate comprises an insulating substrate and a TFT formed on the insulating substrate, and wherein the first electrode is connected to the TFT.

15. The electro phoretic display device according to claim 14, wherein the first electrode is included in a plurality of first electrodes, and wherein at least one of the plurality of spaces face at least two first electrodes of the plurality of first electrodes.

16. The electro phoretic display device according to claim 14, wherein the first electrode is included in a plurality of first electrodes, and at least one of the first electrodes faces at least two spaces.

17. The electro phoretic display device according to claim 1, wherein at least one of the first substrate and the second substrate comprises a plastic insulating substrate.

18. The electro phoretic display device according to claim 1, wherein the fluid is a transparent organic solution.

19. The electro phoretic display device according to claim 1, wherein the total volume of the one or more gel members is 20% to 100% of the total volume of the plurality of spaces.

20. A manufacturing method of an electro phoretic display device comprising:
providing a first substrate including a first electrode;
adhering a film-type gel member comprising a plurality of spaces to the first electrode;
providing fluid and charged particles into the plurality of spaces; and
adhering a second substrate including a second electrode to the gel member.

21. The manufacturing method of the electro phoretic display device according to claim 20, wherein the gel member comprises an inorganic material.

22. The manufacturing method of the electro phoretic display device according to claim 20, wherein the first electrode is included in a plurality of first electrodes, and wherein at least one of the plurality of spaces face at least two first electrodes.

23. The manufacturing method of the electro phoretic display device according to claim 20, wherein the first electrode is included in a plurality of first electrodes, and wherein at least one of the plurality of first electrodes face at least two of the plurality of spaces.
